(19) United States
(12) Patent Application Publication
(10) Pub. No.: US 2022/0302744 A1
(43) Pub. Date: Sep. 22, 2022

(54) PORTABLE SOLAR CHARGER

(71) Applicants: Bernardo Goncalves Arnaud, Rio de Janeiro (BR); Amir Hossein Omidvar, São Paulo (BR)

(72) Inventors: Bernardo Goncalves Arnaud, Rio de Janeiro (BR); Amir Hossein Omidvar, São Paulo (BR)

(21) Appl. No.: 17/206,421

(22) Filed: Mar. 19, 2021

(51) Int. Cl. H02J 7/35; H02J 7/00; H04M 19/08; H04M 1/02

(52) U.S. Cl. CPC H02J 7/35; H02J 7/0045; H02J 7/0048; H04M 19/08; H04M 1/0262; H02J 2207/20

(57) ABSTRACT

Disclosed is a portable solar charger for a smartphone that is operable to charge a smartphone battery using solar energy. The portable solar charger comprises solar panels that convert solar energy into chemical energy for charging the smartphone battery. The portable solar charger comprises a housing that encloses a solar charger board operable to charge a battery of the portable solar charger which is then used to charge the smartphone battery. The portable solar charger is communicably coupled to an application software installed on the smartphone. The portable solar charger is further configured to be attached to a backside of the smartphone. One or more connectors attached to the portable solar charger allows different kinds of smartphones to be used with the portable solar charger.

### TECHNICAL FIELD

The present invention relates generally to field of battery chargers and particularly to portable solar chargers for smartphones.

### BACKGROUND

Smartphones have become a part of daily lives of people in present day scenario. Many people have set their dependencies on the smartphone for various tasks. However, problems arise when the smartphones stop functioning due to depletion of battery. As is known, the smartphone usage is constrained by the battery power. The battery power provided with the smartphone is limited by the size of the battery. As such, the battery size has to be selected taking into account portability of the smartphone. It is not possible to carry battery chargers for smartphone everywhere around. Further, even one caries the battery charger, electrical power sockets might not be available for use. An alternative solution for said problem is the use of solar powered chargers for charging a smartphone battery in presence of sunlight.

Conventionally, the solar chargers are pretty big in size and not practical to carry around. Further, the solar charger attached to the smartphone is required to be put under the sun that makes the smartphone hot and cause damage to the screen as well as the internal components.

In light of the above-mentioned problems associated with existing apparatuses for solar powered mobile chargers, it is highly desirable to have a compact, efficient and portable solar powered mobile battery charger. Consequently, the present invention provides a solar powered battery charger for a smartphone that is compact in size and can be attached to a backside of the smartphone that makes it easier to be carried around with the smartphone.

### SUMMARY

Embodiments of the present disclosure present technological improvements as solutions to one or more of the above-mentioned technical problems recognized by the inventor in conventional systems.

The present invention discloses a portable solar powered battery charger for smartphones wherein the solar powered battery charger comprises a battery inside a housing wherein the battery is charged using solar energy. The battery when charged is used to charge the smartphone battery through one or more connectors provided with the portable solar battery charger. The portable solar charger further provides for real time monitoring of battery charge data on an application software installed on the smartphone. The portable solar charger is further configured to be attached to a backside of a smartphone case/cover through a magnetic plate.

In an aspect of the present invention, there is provided a portable solar charger for a smartphone comprising:

a housing comprising a magnet embedded plate at a bottom side;

a battery;

a solar charger board, attached to the housing, comprising a solar charger unit and a battery charging unit;

at least two solar panels placed parallel to one another on either side of the housing and electrically coupled to the solar charger board;

a booster circuit unit coupled to the battery charger board;

wherein the at least two solar panels are operable to charge the battery when placed under sunlight.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### OBJECT OF THE INVENTION

An object of the invention is to provide a solar powered battery charger for smartphones.

Another object of the invention is to provide a portable design for solar powered smartphone battery charger.

Another object of the invention is to provide a battery charger design suitable to connect to different kinds of smartphones.

Another object of the invention is to provide a compact design of a solar powered battery charger for smartphones.

Another object of the invention is to provide for real time visual display of information pertaining to battery charge data.

### BRIEF DESCRIPTION OF DRAWINGS

The summary above, as well as the following detailed description of illustrative embodiments are better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 depicts a block diagram of the portable solar charger as per the present disclosure.

FIG. 2 depicts the at least two solar panels slided open on the housing.

FIG. 3 depicts the battery removed from the housing.

FIG. 4 depicts the solar charger 100 attached to the smartphone through the magnet embedded plate.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

The present invention discloses a portable solar charger for a smartphone that is operable to charge a smartphone battery using solar energy. The portable solar charger comprises solar panels that convert solar energy into chemical energy for charging the smartphone battery. The portable solar charger comprises a housing that encloses a solar charger board operable to charge a battery of the portable solar charger which is then used to charge the smartphone battery. The portable solar charger is communicably coupled to an application software installed on the smartphone. The portable solar charger is further configured to be attached to a backside of the smartphone. One or more connectors attached to the portable solar charger allows different kinds of smartphones to be used with the portable solar charger.

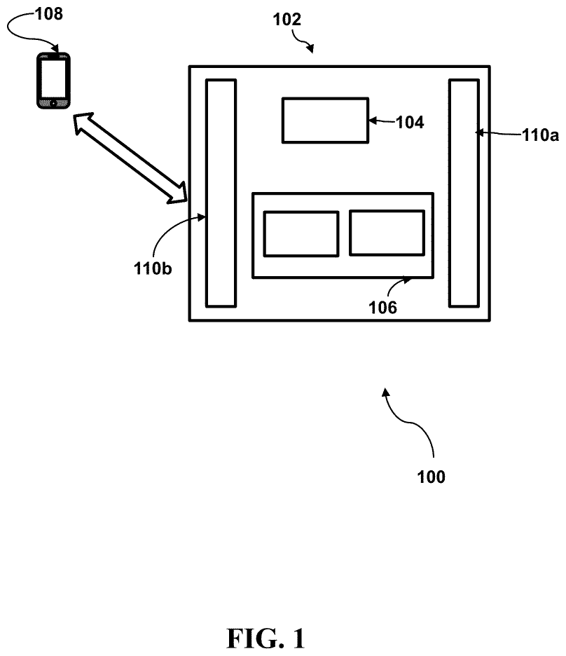

FIG. 1 depicts a block diagram of the portable solar charger 100 as per the present disclosure. The portable solar charger 100 comprises a housing 102 that houses a solar charger board, a battery, at least two solar panels and a booster circuit unit. The housing 102 is made up of a top side and a bottom side wherein the bottom side of the housing comprises a magnet embedded plate. Optionally, the housing 102 is made up of plastic or any other similar suitable material which is lightweight. The housing 102 has slidable rails on either sides to receive one or more solar panels. The magnet embedded plate on the bottom side of the housing allows the portable solar charger to be attached to the backside of the smartphone 108. Optionally, the portable solar charger 100 is attached to a finger-ring holder case for a smartphone.

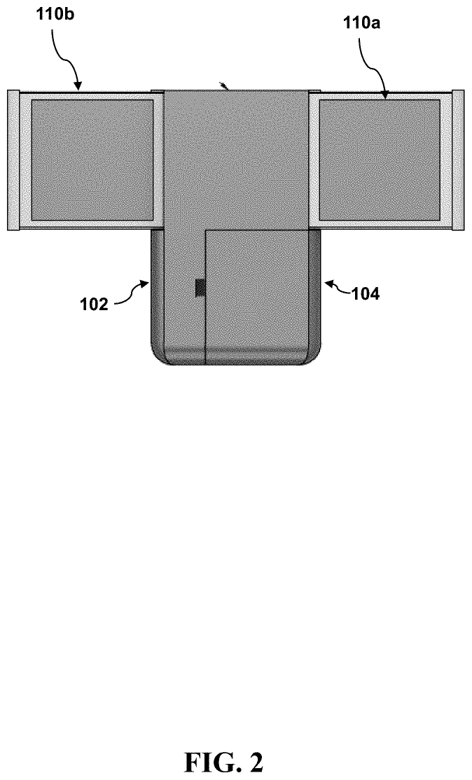

The housing 102 comprises at least two solar panels 110a, 110b placed parallel to one another on either side of the housing 102. The at least two solar panels are slidable underneath one another over the rails placed on the housing. This results in a smaller size area for the portable solar charger 100. In operation, when required for charging, the solar panels are slided open to expand an area under solar light. FIG. 2 depicts the at least two solar panels 110a, 110b slided open on the housing 102. Optionally, the at least two solar panels are hinged upon the rails placed on either side of the housing 102. The solar panels are operable to charge the battery when placed under sunlight.

Throughout this disclosure, the term “solar panel” refers to an assembly of Photovoltaic (PV) modules which are a collection of Photovoltaic cells configured to convert solar energy into electrical energy. Photovoltaic modules use light energy (photons) from the Sun to generate electricity through the photovoltaic effect. Most modules use wafer-based crystalline silicon cells or thin-film cells.

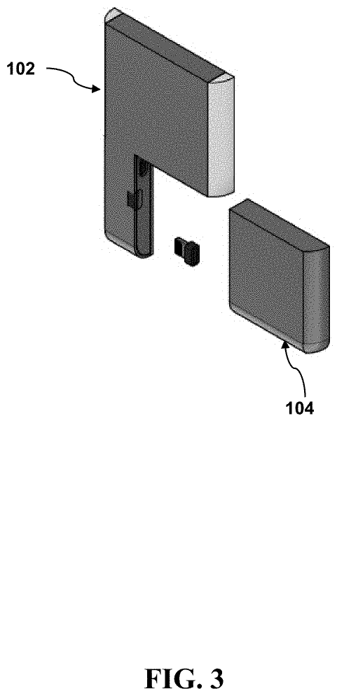

The housing 102 further comprises a battery 104 that is operable to store chemical energy. The battery 104 gets charged through solar energy and when fully charged, is used as a source of power for charging a smartphone battery. There are many types of batteries using different electrolyte materials. In a preferred embodiment, the battery 104 is Li-ion battery. Optionally, the battery is a Li-Polymer battery. The battery is attached to the housing 102. Optionally, the battery 104 is detachable from the housing 102 and operable to be connected to the smartphone without the housing by means of one or more connectors. FIG. 3 depicts the battery removed from the housing.

The portable solar charger 100 further comprises a solar charger board 106 attached to the housing 102. The solar charger board 106 is primarily responsible for charging the battery 104 and subsequently the smartphone battery. The at least two solar panel attached to the housing are electrically coupled to the solar charger board by means of copper plates attached to the housing 102. The solar charger board 106 is a circuit that recharges the battery by resupplying charge carriers (electrons) to it. The solar charger board 106 comprises a solar charger unit and a battery charging unit.

The solar charger unit is operable to charge the battery via the converted electrical energy available from the at least two solar panels. The solar charger unit operates in at least three modes namely a Trickle Mode, a Constant current mode and a Constant voltage mode. The solar charger unit further comprises a solar charge controller that tracks the maximum power available from solar panels under sunlight conditions. The solar charge controller tracks power by measuring the voltage and adjusting the current to get maximum power transfer with prevailing light conditions. This is made possible with maximum power point tracking (MPPT).

The solar charger unit comprises a battery management system that is configured to control an overcharging and over-discharging of the battery 104. The battery management system of the solar charger unit is operable to charge the battery and when overcharging voltage is reached, automatically terminate charging of the battery. The charging process of the battery is monitored in real time by the solar charger unit. A microcontroller integrated with the solar charger unit stores data related to real time charging status of the battery and other information pertaining to the battery such as time since last charges, battery remaining, charging status etc.

The battery charging unit is configured to charge a smartphone battery via the stored charge in the battery 104. The battery charging unit is operable to provide a constant DC power that is used to charge the smartphone battery.

The portable solar charger 100 further comprises a booster circuit unit coupled to the solar charger board 106. The booster circuit unit is operable to increase an output voltage level from the battery 104 and maintain a desired voltage at a desired level. Optionally, the desired voltage level is 5V for smartphone battery charging. In a preferred embodiment of the present invention, the booster circuit unit is a DC to DC Step-up boost voltage converter.

One or more connectors are provided on the portable solar charger to attach the battery charging unit to different kinds of smartphones and charge the smartphone battery. Presence of one or more connectors allows different kinds of smartphone to be plugged into the portable solar charger.

In an embodiment of the present invention, the battery charging unit is operable to charge the smartphone battery wirelessly.

Optionally, the portable solar charger 100 is communicably coupled via one or more data communication network, to an application software installed on the smartphone. The application software connects to the microcontroller present on the solar charger unit and receives real time data related to the battery 104. The application software is operable to display, on graphical user interface of the smartphone, a battery charge status and information pertaining to the battery such as a charging time, last charged status, battery remaining status, overcharge status etc. Further, the application software is operable to display a real time charging process of the battery 104 being charged from solar power. The application software allows for controlling the charging of the battery as well as the smartphone battery through the microcontroller present on the solar charger board. In an embodiment, a user of the application software can switch on or switch off the battery charging from solar power though the application software. Similarly, the smartphone battery being charged from the battery of the portable solar charger can be controlled from the application software.

Throughout this disclosure, the term “application software” refers to applications configured to operate on smartphones. Preferably, the application software as per the present disclosure are native apps but web applications are covered as well under the scope of this disclosure.

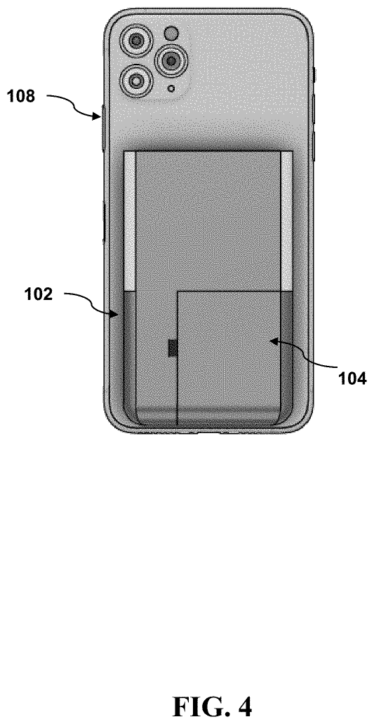

FIG. 4 depicts the solar charger 100 attached to the smartphone through the magnet embedded plate.

In operation, the at least two solar panels placed on the housing are slided open and placed under sunlight to receive maximum amount of solar energy. A plurality of PV cells integrated on the solar panels convert solar energy into electrical energy and charges the battery attached to the housing. The charging of the battery is done through the solar charger unit of the solar charger board. The microcontroller is operable to send real time data on charging of the battery to the application software and the same is displayed on the graphical user interface of the smartphone. The microcontroller is further operable to send a notification of full charge to the smartphone. Alternatively, an alarm signal is generated and the charging is automatically cut-off. Once the battery is charged, the at least two solar panels are slided back into the housing. The battery is then used to charge the smartphone battery through the one or more connectors placed on the housing and the battery charging unit. Optionally, in some embodiments, the battery can be removed from the housing and connected directly to the smartphone without the housing.

One or more components of the invention are described as unit for the understanding of the specification. For example, a unit may include self-contained component in a hardware circuit comprising of logical gate, semiconductor device, integrated circuits or any other discrete component. The unit may also be a part of any software programme executed by any hardware entity for example processor. The implementation of unit as a software programme may include a set of logical instructions to be executed by a processor or any other hardware entity.

Additional or less units can be included without deviating from the novel art of this disclosure. In addition, each unit can include any number and combination of sub-units, and systems, implemented with any combination of hardware and/or software units.

A data communication network includes or interfaces with any one or more of an RS-232 serial connection, an IEEE-1394 (Firewire) connection, a Fiber Channel connection, an IrDA (infrared) port, a SCSI (Small Computer Systems Interface) connection, Bluetooth, ZigBee, Wi-Fi, a Universal Serial Bus (USB) connection or other wired or wireless, digital or analog interface or connection, mesh or Digi® networking.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A portable solar charger for a smartphone comprising:
a housing comprising a magnet embedded plate at a bottom side;
a battery;
a solar charger board, attached to the housing, comprising a solar charger unit and a battery charging unit;
at least two solar panels placed parallel to one another on either side of the housing and electrically coupled to the solar charger board;
a booster circuit unit coupled to the battery charger board;
wherein the at least two solar panels are operable to charge the battery when placed under sunlight.

2. The portable solar charger of claim 1 wherein the at least two solar panels are removably attached to the housing through copper plates.

3. The portable solar charger of claim 1 wherein the housing is attached to a backside of a smartphone case.

4. The portable solar charger of claim 1 wherein one or more connectors are provided to charge the smartphone though the battery.

5. The portable solar charger of claim 1 wherein the at least two solar panels are slidable underneath one another over rails placed on the housing.

6. The portable solar charger of claim 1 wherein the battery is removable from the housing.

7. The portable solar charger of claim 1 wherein the smartphone is charged through the battery wirelessly.

8. The portable solar charger of claim 1 wherein the booster circuit unit is a DC to DC booster circuit and is operable to increase an output voltage of the portable solar charger.

9. The portable solar charger of claim 1 wherein the portable solar charger is communicably coupled to an application software installed on the smartphone.

10. The portable solar charger of claim 1 wherein the application software is operable to display, on a graphical user interface of the smartphone, a battery charge status and information pertaining to the battery.

11. The portable solar charger of claim 1 wherein solar charger unit is operable to charge the battery through the at least two solar panels.

12. The portable solar charger of claim 1 wherein the battery charger unit is operable to charge the smartphone battery through the one or more connectors.
